(19) United States
(12) Patent Application Publication
(10) Pub. No.: US 2013/0089811 A1
(43) Pub. Date: Apr. 11, 2013

(54) SEAL ASSEMBLY AND METHOD FOR SELF-HEALING GLASS SEAL

(71) Applicants: John E. Holowczak, South Windsor, CT (US); Sonia Tulyani, South Windsor, CT (US); Elllen Y. Sun, South Windsor, CT (US); Jean Yamanis, South Glastonbury, CT (US)

(72) Inventors: John E. Holowczak, South Windsor, CT (US); Sonia Tulyani, South Windsor, CT (US); Elllen Y. Sun, South Windsor, CT (US); Jean Yamanis, South Glastonbury, CT (US)

(21) Appl. No.: 13/496,883

(22) PCT Filed: Sep. 21, 2009
(86) PCT No.: PCT/US09/57646

§ 371 Date: Mar. 18, 2012

(51) Int. Cl. H01M 8/02

(52) U.S. Cl. CPC H01M 8/0282
USPC 429/510; 156/94; 501/14

(57) ABSTRACT

A seal assembly includes first and second solid oxide fuel cell components and a self-healing glass between the components. The glass seal includes 35-60 wt % alkaline earth oxide, 2-15 wt % boron oxide, and 25-62 wt % silicone oxide.

### BACKGROUND OF THE DISCLOSURE

This disclosure relates to glass seals. Devices such as solid oxide fuel cells, oxygen sensors and the like typically utilize components that are formed from different types of materials, such as dissimilar metallic alloys and ceramics. As an example, the fuel cell may include a ceramic electrolyte and a metallic frame. Seals may be used between components to limit leakage of reactant gases, for example.

One challenge associated with sealing relates to thermal cycling-induced stresses from heating and cooling between ambient and operating temperatures. Thermal cycling causes differential thermal expansion among the different materials and thereby induces thermal stresses on any seals that are between the components. The thermal stresses can cause the seals to crack. The cracks may form leak paths for escape of a reactant gas.

### SUMMARY OF THE DISCLOSURE

An exemplary seal assembly includes first and second fuel cell components and a self-healing glass between the components. The glass seal includes 35-60 wt % alkaline earth oxide, 2-15 wt % boron oxide, and 25-62 wt % silicon oxide, such as silicon dioxide.

An exemplary self-healing glass seal material includes 35-60 wt % alkaline earth oxide, 2-15 wt % boron oxide, and 25-62 wt % silicone oxide.

An exemplary method of sealing includes sealing first and second fuel cell components with a self-healing glass seal in between to establish a first leak rate through the glass seal. The self-healing glass seal may include a composition as described above. The self-healing glass seal may be used under conditions that cause the glass seal to crack such that the first leak rating increases to a second, higher leak rate. The glass seal may then be heated to a healing temperature below about 700° C. to heal the crack and thereby establish a third leak rate that is less than the second leak rate.

### BRIEF DESCRIPTION OF THE DRAWINGS

FIG. 1 illustrates an example seal assembly.

FIG. 2 illustrates an example seal assembly within a solid oxide fuel cell assembly.

The various features and advantages of the disclosed examples will become apparent to those skilled in the art from the following detailed description. The drawings that accompany the detailed description can be briefly described as follows.

### DETAILED DESCRIPTION OF THE PREFERRED EMBODIMENT

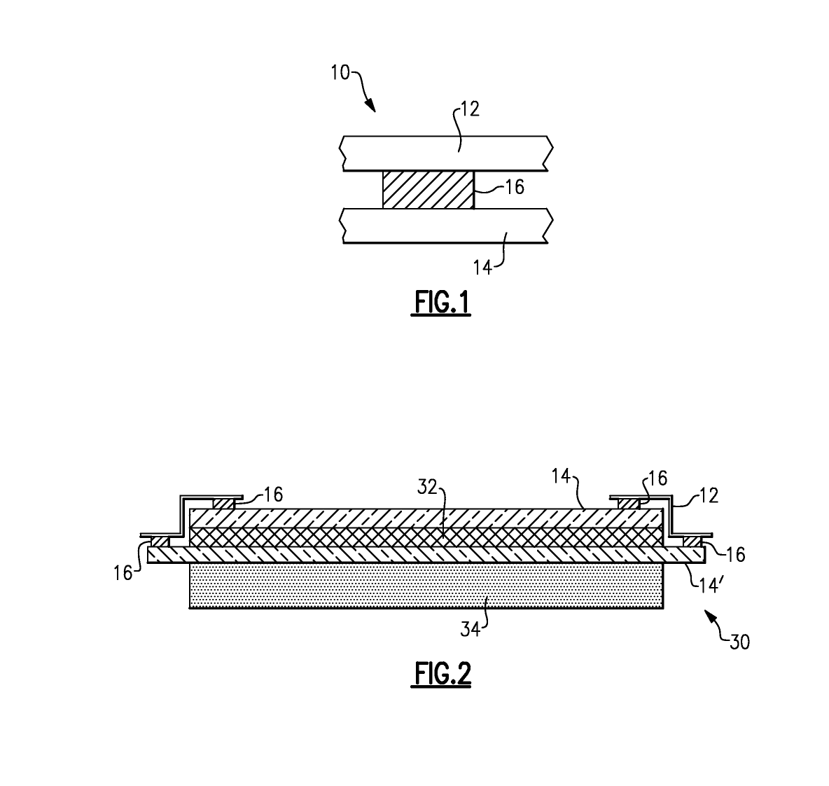

FIG. 1 illustrates selected portions of an example seal assembly 10. The seal assembly 10 may be within a fuel cell assembly, such as a solid oxide fuel cell. In this example, the seal assembly 10 includes a first fuel cell component 12 and a second fuel cell component 14. A self-healing glass seal 16 is located between the first and second fuel cell components 12 and 14.

As will be described, the self-healing glass seal 16 provides the benefit of repairing itself when cracks form such that leakage through the glass seal decreases. In this example, the composition of the glass seal 16 contributes to the self-healing property. The composition includes 35-60 wt % alkaline earth oxide, 2-15 wt % of boron oxide and 25-62 wt % silicon oxide, such as silicon dioxide.

A premise of the given composition is that the glass seal 16 does not significantly crystallize with long exposure times to temperatures less than or equal to 800° C., softens at a temperature within the operating temperature of the fuel cell, and is self-reactive at such temperatures to provide self-healing. For instance, the boron oxide impedes crystallization of the glass seal 16 and the alkaline earth oxide facilitates providing a low softening temperature and the needed chemical activity to self repair any cracking.

The alkaline earth element of the alkaline earth oxide may be selected from barium, calcium, strontium, magnesium, or mixtures thereof. In some examples, the alkaline earth oxide may include only barium oxide, or only calcium oxide and magnesium oxide. The magnesium oxide may contribute to lowering the thermal expansion of the glass seal 16 and may therefore be present in lesser amount than the amount of calcium oxide.

In a further example, the glass seal 16 includes 48-52 wt % of an alkaline earth oxide, 8-12 wt % of the boron oxide, and 35-45 wt % of the silicon oxide. In any of the exemplary compositions, the presence of certain other oxides may need to be controlled. For instance, zirconia and zinc oxide may be limited to an amount less than 1 wt % because these substances may promote crystallization or change the softening temperature of the glass seal 16 and therefore compromise the desired properties.

In a further example, the glass seal may include about 50 wt % barium oxide, about 10 wt % boron oxide, and about 35 wt % silicon dioxide. The glass seal 16 may include impurities that do not affect the properties of the seal or elements that are unmeasured or undetectable in the material. In some examples, the glass seal 16 may include only the given elements in the given percentages.

The first and second fuel cell components 12 and 14 may be any known components in a fuel cell. For example, the components 12 and 14 may each be metallic, or at least one of the components 12 or 14 may be a ceramic material. FIG. 2 illustrates an example implementation of the seal assembly 10 in a solid oxide fuel cell assembly 30. In this example, the first fuel cell component 12 may be a metallic frame and the second fuel cell component 14 may be a ceramic fuel cell having an electrolyte between electrodes (not shown).

The metallic frame of the first fuel cell component 12 may be any type of metal or alloy that is typically used in a fuel cell. For instance, the metal frame may be formed from a stainless steel material, nickel alloy, or other suitable alloy. The ceramic electrolyte of the fuel cell may be any type of solid oxide electrolyte, such as stabilized (fully or partially) zirconia, ceria (CeO₂) doped with rare earth metal oxide(s), or gallate (e.g., strontium-doped lanthanum gallate).

As illustrated, the solid oxide fuel cell assembly 30 includes the self-healing glass seal 16 between the metallic frame of the first cell component 12 and the ceramic electrolyte of the second fuel cell component 14. One side of the metallic frame is adjacent to the ceramic electrolyte and the other side of the frame is adjacent to a metallic separator plate 14′, which in this case separates a mesh 32 from a cathode interconnect 34. Another glass seal 16 is located between the end of the metallic frame and the separator plate 14′. Thus, each metallic frame (one on the left and one on the right in FIG. 2) is sealed at one side relative to the ceramic electrolyte and at its other side relative to the separator plate 14′.

In operation, the solid oxide fuel cell assembly 30 may be operated through cyclic heating and cooling between ambient and operating temperatures. The temperature may reach as high as about 850° C. and cause thermal expansion/contraction of the illustrated components. As is known, metals and metallic alloys have a different coefficient of thermal expansion than ceramic materials, such as the ceramic electrolyte. The self-healing glass 16 may also have a different coefficient of thermal expansion than the metals, alloys, or ceramic electrolyte at temperatures below the softening point of the glass. The difference in expansion and contraction causes stresses on the glass seals 16 that may cause the glass seals 16 to crack during cool down. In this case, the glass seals 16 are able to self-heal the cracks during subsequent reheating, thereby decreasing a leak rate across the glass seals 16.

As an example, any one of the glass seals 16 may initially exhibit a first leak rate. Upon cool down from operating temperature and cracking, the glass seal 16 may exhibit a second, higher leak rate as fluid escapes at a greater rate through the cracks. However, as the temperature of the solid oxide fuel cell assembly 30 increases to a healing temperature of the glass seal 16, the cracks heal to reduce the leak rate to a third leak rate that is less than the second leak rate. A premise of self-healing is that the composition of the glass seal 16 suppresses crystallization such that the glass material becomes soft at the healing temperature. The healing temperature may be below about 900° C., and in some cases be below 700° C. That is, the healing temperature is within or below the operating temperature range of the solid oxide fuel cell assembly 30. In one example, healing begins to take place at temperatures as low as about 300° C.

At the healing temperature, the glass material of the glass seal 16 softens such that the crack width may be reduced. Furthermore, the crack surfaces are reactive due to the barium oxide (or other alkaline earth modifier) of the glass material composition and react to induce chemical bonding across the crack interface to at least partially patch the crack and thereby facilitate reduction of gas leakage to acceptable levels. Preferred leak rates for solid oxide fuel cell seals are below about 0.2% of total gas flow volume at temperatures of about 750° C.

The glass seals 16 may be applied to or formed in the solid oxide fuel cell 30 in a known manner. For example, the glass material of the glass seals 16 may be melted, crushed, powdered and then combined with a binder to form a tape that can be applied in the solid oxide fuel cell assembly 30 to form the glass seals 16. Alternatively, the powdered glass material can be combined with a suitable carrier, such as an organic solvent, and sprayed or applied to the desired portions of the solid oxide fuel cell assembly 30 to form the glass seals 16.

As an example of the self-healing properties, a commercially available glass was tested as a comparison to two different glass compositions of the self-healing glass seal 16 disclosed herein. Each glass was used to bond together 441 stainless steel test chambers that could be heated and pressurized to evaluate leak rates. Each of the three samples were then pressurized and subjected to thermal cycling between room temperature and 750° C. to evaluate leak rate.

The sample glasses included a first glass composition of the self-healing glass seal 16 (sample 1), a commercial glass sealing frit (sample 2), and a second glass composition of the self-healing glass seal 16 (sample 3). The sample 1 glass had an approximate composition of 50 wt % barium oxide, 10 wt % boron oxide, and 39 wt % silicon dioxide. The sample 2 glass had a composition of approximately 46 wt % silicon dioxide, 30 wt % calcium oxide, 20 wt % aluminum oxide, 2.5-3.7 wt % barium oxide and less than 1 wt % magnesium oxide. The sample 3 glass had a composition of approximately 40 wt % silicon dioxide, 37 wt % calcium oxide, 19 wt % aluminum oxide, 4 wt % barium oxide and less than 1 wt % magnesium oxide.

After twenty-five thermal cycles, the sample 1 glass exhibited a leak rate of less than 10% at 80 psi at room temperature and a leak rate of zero at 10 psi and 750° C., indicating self-healing behavior through complete recovery of leak rate at elevated temperatures.

After ten thermal cycles, the sample 2 glass exhibited leak rates at room temperature of about 1.8% and leak rates of about 0.5% at 750° C., which indicates no self-healing capability.

After five thermal cycles, the sample 3 glass exhibited leak rates of less than 0.2% at room temperature and a leak rate of zero at 750° C., indicating self-healing behavior through complete recovery of leak rate at elevated temperatures. Further, after 25 thermal cycles, the sample 3 glass exhibited no appreciable leak rate at room temperature. Other compositions within the examples disclosed herein are expected to also exhibit such self-healing properties.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A seal assembly comprising:
first and second fuel cell components; and
a self-healing glass seal between the first and second fuel cell components, the self-healing glass seal including 35-60 wt % alkaline earth oxide, 2-15 wt % boron oxide, and 25-62 wt % silicon oxide.

2. The seal assembly as recited in claim 1, wherein each of the first and second fuel cell components are metallic.

3. The seal assembly as recited in claim 1, wherein at least one of the first or second fuel cell components is a ceramic material.

4. The seal assembly as recited in claim 3, wherein the ceramic material is selected from a group consisting of zirconia, ceria, gallate, and combinations thereof.

5. The seal assembly as recited in claim 1, wherein one of the first and second fuel cell components is metallic and the other of the first and second fuel cell components is a ceramic material.

6. The seal assembly as recited in claim 1, wherein the alkaline earth oxide includes at least one element selected from the group consisting of barium, calcium, strontium, and magnesium.

7. The seal assembly as recited in claim 1, wherein the alkaline earth oxide consists of barium oxide.

8. The seal assembly as recited in claim 1, wherein the alkaline earth oxide consists of calcium oxide and magnesium oxide.

9. The seal assembly as recited in claim 1, wherein the self-healing glass seal includes 48-52 wt % alkaline earth oxide, 8-12 wt % boron oxide, and 35-45 wt % silicon oxide.

10. The seal assembly as recited in claim 1, when the self-healing glass seal includes about 50 wt % alkaline earth oxide, about 10 wt % boron oxide, and about 40 wt % silicon oxide.

11. The seal assembly as recited in claim 1, wherein the self-healing glass seal consists essentially of 48-52 wt % barium oxide as the alkaline earth oxide, 8-12 wt % boron oxide, and 35-45 wt % silicon oxide.

12. A self-healing glass seal material comprising:
35-60 wt % alkaline earth oxide;
2-15 wt % boron oxide; and
25-62 wt % silicon oxide.

13. The self-healing glass seal material as recited in claim 12, wherein the alkaline earth oxide includes at least one element selected from the group consisting of barium, calcium, strontium, and magnesium.

14. The self-healing glass seal material as recited in claim 12, wherein the alkaline earth oxide consists of barium oxide.

15. The self-healing glass seal material as recited in claim 12, wherein the alkaline earth oxide consists of calcium oxide and magnesium oxide.

16. The self-healing glass seal material as recited in claim 12, wherein the self-healing glass seal includes 48-52 wt % alkaline earth oxide, 8-12 wt % boron oxide, and 35-45 wt % silicone oxide.

17. The self-healing glass seal material as recited in claim 12, when the self-healing glass seal includes about 50 wt % alkaline earth oxide, about 10 wt % boron oxide, and about 40 wt % silicone oxide.

18. The self-healing glass seal material as recited in claim 12, wherein the self-healing glass seal consists essentially of 48-52 wt % barium oxide as the alkaline earth oxide, 8-12 wt % boron oxide, and 35-45 wt % silicone oxide.

19. A method of sealing comprising:
sealing first and second fuel cell components with a self-healing glass seal there between to establish a first leak rate through the self-healing glass seal, the self-healing glass seal including 35-60 wt % alkaline earth oxide, 2-15 wt % boron oxide, and 25-62 wt % silicon oxide;
using the self-healing glass seal under conditions that cause the self-healing glass seal to crack such that the first leak rate increases to a second, higher leak rate; and
heating the self-healing glass seal to a healing temperature below about 700° C. to heal the crack and thereby establish a third leak rate that is less than the second leak rate.

20. The method as recited in claim 19, including selecting the healing temperature to be about 350-750° C.
